(19) United States
(12) Patent Application Publication
(10) Pub. No.: US 2019/0369585 A1
(43) Pub. Date: Dec. 5, 2019

(54) METHOD FOR DETERMINING A PHYSICAL CONNECTIVITY TOPOLOGY OF A CONTROLLING DEVELOPMENT SET UP FOR A REAL-TIME TEST APPARATUS

(71) Applicant: dSPACE digital signal processing and control engineering GmbH, Paderborn (DE)

(72) Inventor: Bjoern Meyer, Paderborn (DE)

(21) Appl. No.: 16/420,203

(22) Filed: May 23, 2019

(30) Foreign Application Priority Data
May 29, 2018 (DE) 102018112803.7
May 29, 2018 (EP) 18174804.7

(51) Int. Cl. G05B 19/05; G05B 19/10

(52) U.S. Cl. CPC G05B 19/05; G05B 2219/23446; G05B 19/108

(57) ABSTRACT

A method for determining a physical connection topology of a test device with real-time capability and set up for control device development includes: determining logical communication links between a plurality of simulation models; and automatically determining the physical connection topology by specifying direct physical communication links between the plurality of data processing units based on the respective specified quantities of physical interfaces of the plurality of data processing units. Specifying the direct physical communication links includes determining, for each of the logical communication links, whether a direct physical communication link corresponding to the logical communication link forms part of the physical connection topology.

### CROSS-REFERENCE TO RELATED APPLICATIONS

Priority is claimed to German Patent Application No. DE 102018112803.7, filed on May 29, 2018, and European Patent Application No. EP 18174804.7, filed on May 29, 2018, the entire disclosures of which are incorporated by reference herein.

### FIELD

The present invention relates to the development of control devices such as are used, for example, in the automotive industry or in the aircraft industry for controlling technical systems, such as motors or brakes. In particular, the present invention relates to test devices used in the development process of the control device, as well as methods for setting up such test devices for performing simulations for control device development.

### BACKGROUND

The development of control devices has become a highly complex process. New control devices or new control functions should be tested as early as possible in the development process in order to check their general functionality and to specify the direction of further development. Towards the end of the development process, it is important to test the already far developed control device as comprehensively as possible in order to make necessary modifications on the basis of the test results before the control device is used or goes into series production so that it operates as desired under all possible circumstances during subsequent operation.

At a very late stage of the development process, so-called hardware-in-the-loop simulators (HIL simulators/HIL simulation devices) are used. Such HIL simulators contain a model of the technical system to be controlled, the model being present in software. In addition, the HIL simulator may include other models of technical systems that are located in the environment of the control device and of the technical system to be controlled and that interact with the control device and/or the technical system to be controlled. The HIL simulator may thus generally include a plurality of simulation models. These simulation models are often run on various processors and exchange data with each other. The HIL simulator furthermore contains an input/output interface to which can be connected the already far developed control device already physically present in hardware, which is also referred to as a hardware implementation of the control device. The functionality of the control device can now be tested in various simulation runs, wherein the reactions of the model of the technical system to be controlled to the signals of the control device and the reactions of the control device to events predetermined by the model of the technical system to be controlled can be observed. Optionally, the behavior of other technical systems from the environment of the control device and of the technical system to be controlled can also be observed. In this case, normal operation and faults in the technical system to be controlled and faults in the control device as well as faults in the communication between the control device and the system to be controlled, such as a cable bridge, and faults in the power supply, such as shorts, can be simulated. The HIL simulator is an example of a test device with real-time capability and set up for control device development. The term “test device” is used synonymously herein with the terms “simulator,” “simulation unit” and “simulation device.”

In contrast, so-called rapid control prototyping (RCP) is a development step that is closer to the beginning of the development process. During RCP, the test device is used on the control-device side. The test device contains a model of the control device to be tested. Since development is at an early stage, the model of the control device to be tested is still fairly rudimentary in comparison to the subsequent final control device. In addition, a hardware implementation of the control device is not yet available; on the contrary, the model in the test device of the control device to be tested is a software model. Furthermore, the test device can contain further models, such as models of technical systems with which the control device is to subsequently interact in addition to the system to be controlled. A broad environment of the control device can thus be simulated in the test device. The test device can be connected via an input/output interface to the technical system to be controlled itself or to the existing control device for the technical system to be controlled. In the first case, there is a direct connection between the control device to be tested, in the form of a software model, and the physically existing technical system to be controlled. In the second case, the existing control device is the technical system to be controlled by the RCP test device. This control of the existing control device leads to a modification of the control methods of the existing control device, as a result of which a new control functionality can be tested via the externally connected RCP control device. This arrangement is also referred to as bypassing.

In general, the effort needed to prepare an HIL simulation is quite high, especially if a plurality of simulation models run on different processors or data processing units interact in the HIL simulator. In the preparation of the simulation, communication between the simulation models is configured, among other things. A suitable configuration of the communication between the simulation models is of great importance since data exchange between the simulation models has repercussions on the real-time capability of the test device. Even in the case of more complex RCP simulations, the effort needed to prepare a simulation can be quite high.

Accordingly, it would be desirable to provide a method which facilitates or improves the configuration of the communication between the simulation models.

### SUMMARY

In an exemplary embodiment, the present invention provides a method for determining a physical connection topology of a test device with real-time capability and set up for control device development. The test device comprises a plurality of data processing units, wherein each data processing unit has a specified quantity of physical interfaces for communication between the data processing units. A plurality of simulation models are associated with the plurality of data processing units, wherein the plurality of simulation models comprises at least one model of a technical system to be controlled and/or at least one model of a controller of a technical system and/or at least one technical environment model. The method comprises: determining logical communication links between the plurality of simulation models, wherein each logical communication link represents a data link between two of the plurality of simulation models, and wherein the specified quantity of physical interfaces for a respective data processing unit of the plurality of data processing units is smaller than a quantity of logical communication links associated with the respective data processing unit; and automatically determining the physical connection topology by specifying direct physical communication links between the plurality of data processing units based on the respective specified quantities of physical interfaces of the plurality of data processing units, wherein specifying the direct physical communication links includes determining, for each of the logical communication links, whether a direct physical communication link corresponding to the logical communication link forms part of the physical connection topology.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a block diagram of an HIL simulator as a test device on which methods according to exemplary embodiments of the invention can be executed, together with a control device connected thereto;

FIG. 2 shows a block diagram of an HIL simulator as a test device, in which the data processing units and simulation models for simulating an engine and a gearbox are set up, and the logical communication links present between the simulation models;

FIG. 3 shows the HIL simulator of FIG. 2 and illustrates the physical connection topology as it may have been determined as a result of a method according to an exemplary embodiment of the invention; and

FIG. 4 shows the HIL simulator of FIG. 2 and illustrates the physical connection topology as it may have been determined as a result of a method according to another exemplary embodiment of the invention.

### DETAILED DESCRIPTION

Exemplary embodiments of the invention include a method for determining a physical connection topology of a test device having real-time capability and set up for control device development, wherein the test device comprises a plurality of data processing units, wherein each data processing unit has a specified quantity of physical interfaces for communication between the data processing units, and wherein a plurality of simulation models is associated with the plurality of data processing units, wherein the plurality of simulation models comprises at least one model of a technical system to be controlled and/or at least one model of a controller of a technical system, and/or at least one technical environment model. The method comprises the following steps: determining the logical communication links between the simulation models, wherein each logical communication link represents a data link between two of the plurality of simulation models, and wherein the specified quantity of physical interfaces for at least one of the plurality of data processing units is smaller than the quantity of logical communication links associated with the data processing unit in question; and automatically determining the physical connection topology by defining direct physical communication links between the data processing units while taking into consideration the respective quantities of physical interfaces, wherein defining the direct physical communication links for each of the logical communication links determines whether a direct physical communication link corresponding to the logical communication link forms part of the physical connection topology.

Exemplary embodiments of the invention make possible a targeted, automated determination of the physical connection topology based on the logical communication links between the simulation models that are required for simulation. In contrast to earlier approaches in which the data processing units were physically connected without reference to the logical communication links, e.g. via a regular connection topology, such as a ring topology, or via a random connection topology, the method can provide improved data transmission properties since direct physical communication links are determined specifically for logical communication links. Compared to other previous approaches in which the physical connections were determined manually with a greater or lesser expert knowledge of the simulation models used, the method enables in an automated manner a targeted adaptation of the physical connection topology to the logical communication links between the simulation models. For the respective quantities of physical interfaces available to the individual data processing units, the physical communication links can be adapted to the logical communication links in an automated, efficient and targeted manner. In addition, with the method according to exemplary embodiments of the invention, the physical connection topology can also be created without any detailed knowledge of the simulation models. In this way, even when the contents of the simulation models are not known, which can often be the case for reasons of confidentiality, an effective physical communication topology can be determined on the basis of the logical communication links.

The test device comprises a plurality of data processing units, and a plurality of simulation models is associated with the plurality of data processing units. One or more simulation models can in this case be associated with each one of the plurality of data processing units. It is also possible for one or more of the totality of data processing units present in the test device to not have any simulation model. Each simulation model is associated with exactly one data processing unit. That is, each simulation model is set up to run on exactly this one data processing unit. The simulation models can be loaded into the corresponding data processing units in an early phase of the configuration of the simulation. For the determination of the logical communication links, the simulation models may be present in a comparatively abstract form, e.g. in a high-level programming language, or they may be present in an executable, i.e. compiled, form on a data processing unit.

The test device has a plurality of data processing units. Each data processing unit may comprise a processor or a processor core. Here, the data processing unit may have a suitable periphery in addition to the processor/processor core. It can be equipped, for example, with a routing capability to other data processing units. For example, it is possible for the simulation models associated with a particular data processing unit to be calculated on the processor of that data processing unit, while data transmitted to that particular data processing unit but intended for a different data processing unit are forwarded without being processed in the processor.

The plurality of simulation models is divided amongst the plurality of processor units. For a simulation running in the test device, the simulation models depend on the data exchange with one another or are set up to exchange data with one another. For the overall simulation, however, it is in most cases not necessary or desired for each of the plurality of simulation models to exchange data with every other of the simulation models. Amongst the plurality of simulation models, there is rather a plurality of pairs of simulation models that exchange data for the overall simulation. These pairs of simulation models form the basis for the logical communication links.

The logical communication links between the simulation models can be determined, for example, by analyzing the simulation models and/or by reading in the required logical communication links from a corresponding file or other storage medium from an earlier processing step. As a result, determination of the logical communication links may yield a list of pairs of simulation models that are in each case to exchange data in the simulation.

Each logical communication link represents a data link between two of the plurality of simulation models. The term “data link” here refers to a data link required or desired for a given simulation, i.e. a data exchange path required or desired for a given simulation. The data exchange can in this case be unilateral or bilateral.

The specified quantity of physical interfaces may be the quantity of physical interfaces available for communication amongst the data processing units. In other words, the specified quantity of physical interfaces may be the total quantity of physical interfaces of the data processing units minus any physical interfaces used for other purposes, such as the physical interfaces used for communication with the input/output interface of the test device. It is also possible for the specified quantity of physical interfaces to be the total number of physical interfaces of that particular data processing unit, wherein the logical communication links to outside the test device via the input/output interface of the test device are also taken into account in the process flow.

The physical connection topology is determined automatically by specifying direct physical communication links between the data processing units while taking into account the corresponding quantities of physical interfaces. In the process, it is specified for each of the logical communication links whether a corresponding direct physical communication link forms part of the physical connection topology. Automated determination can at the same time satisfy further secondary conditions. For example, the physical connection topology may be such that there are at least indirect physical communication links for all logical communication links. In other words, simulation models that have a logical communication link to each other cannot form part of different islands of connected simulation models. Furthermore, it is both possible for direct physical communication links to be determinable only when there is a corresponding logical communication link, and possible for direct physical communication links to be specified for which there are no corresponding logical communication links. It is important that it is specified for each of the logical communication links whether the logical communication link is implemented in the physical connection topology in the context of a direct physical communication link or of an indirect physical communication link.

According to a further embodiment, the direct physical communication links are specified on the basis of an optimization function. In this way, specification of the direct physical communication links is not only adapted in a targeted manner to the logical communication links but also aims at the most advantageous use possible of the limited resources of the physical interfaces for implementing the logical communication links. An optimization function provides an objectified comparative value of different physical connection topologies and thus represents an optimization criterion on the basis of which the limited resource of the physical interfaces of the data processing units can be assigned to the physical communication links. The optimization function can have one or more components which may be weighted with respect to each other. If there are several physical connection topologies that are optimal according to the optimization function, the physical connection topology can be selected randomly from the optimal solutions. It is also possible for further parameters to be used for a downstream comparison, e.g., the parameters discussed below with reference to the optimization function as such.

According to another embodiment, the optimization function takes into account the number of those logical communication links for which no direct physical communication link forms part of the physical connection topology. In particular, the optimization function may aim at minimizing the number of indirect physical communication links. In other words, the optimization function may be designed to minimize the indirect physical communication links. In this way, those physical communication links are minimized for which data between the data source and the data sink must pass through one or more intermediate data processing units. Such an optimization function is thus a good indication that few data need to be forwarded in data processing units, which is generally disadvantageous for the data transmission times of the logical communication links and ties up resources in the forwarding data processing units. Such a minimization of the number of indirect physical communication links is also an optimization goal that can be achieved with comparatively little complexity.

According to another embodiment, the optimization function takes into account the number of data processing units passed through for those logical communication links for which no direct physical communication links form part of the physical connection topology. In particular, the optimization function can have as its optimization goal the minimization of the number of forwarding data processing units of the indirect physical communication links, more particularly the minimization of the number of forwarding data processing units over the totality of the indirect physical communication links. In other words, the optimization function can have as its optimization goal the minimization of so-called hops in the indirect physical connections. Such a minimization of hops is a good indication that the instances of handover of data in data processing units associated with time delays and the allocation of resources are minimized. Such a minimization of hops can also be implemented with a relatively low complexity since a corresponding number of hops can be assigned directly to each indirect physical connection.

According to a further embodiment, the optimization function takes into account at least one hardware property of at least one of the data processing units, the physical interfaces of the data processing units, and the physical communication links. Taking the hardware properties into account during the exchange of data between simulation models on various data processing units makes a relatively concrete assessment possible as to which indirect physical communication links have what level of negative effects on the efficiency of the data exchange. Instead of or in addition to abstract variables, such as the number of indirect physical connections or the number of hops, the optimization function takes into account the specific properties of direct and/or indirect physical communication links and thus better adapts the optimization goal to the actual hardware.

According to another embodiment, the at least one hardware property includes at least one property of latency, maximum data throughput, and collision handling. The hardware properties of latency and maximum data throughput are particularly relevant in data processing units which are used in indirect physical connections as forwarding units, i.e. as routers. The latency and maximum data throughput of the data processing units functioning as routers may have a decisive influence on the total transmission time of data between the data processing unit functioning as a data source and the data processing unit functioning as a data sink. The term “collision handling” relates to the bypassing of the hardware resource, e.g. a physical communication link, in the case where both connected data processing units want to use the physical communication link at the same time and the data collide on the hardware resource. In this respect, the hardware property may be that there are measures for collision avoidance or for collision detection, paired with repeated data transmissions, which then bring about an additional delay in the data exchange.

According to a further embodiment, the optimization function takes into account at least one communication property of the logical communication links. In this way, the logical communication links can be weighted on the basis of at least one communication property so that for logical communication links which are more comprehensive and/or more real-time-critical, there may be a tendency towards direct physical communication links in the optimization function. In this way, the physical connection topology can be further refined for the overall simulation.

According to another embodiment, the at least one communication property comprises at least one of the data transmission direction, the clock rate of data to be transmitted, the data volumes, and the data requirements of asynchronous events. The data volume can be known for a certain logical communication link for a certain clock rate or for a certain period of time. It is also possible for the clock rate to be known and for the data volume to be statistically modeled. In asynchronous events, the frequency or probability of occurrence can likewise be known or be statistically modeled. In the case of simulation in control device development, the interconnected simulation models often exchange predefined data packets, i.e. fixed data volumes, at fixed predetermined points in time, i.e. with fixed predetermined timing. However, it is also possible for data to be exchanged instead of and/or in addition to such fixed data packets when certain events occur. Such events are referred to as asynchronous events.

According to another embodiment, the optimization function is used to determine the physical connection topology that allows as fast and/or stable a data exchange as possible of the simulation models over the totality of logical communication links. In particular, for a simulation step or for a specific number of simulation steps or for a similar optimization horizon can be determined that physical connection topology in which the entirety of all data to be transmitted is transmitted fastest or in which the totality of all data is transmitted with the greatest possible probability in a time frame with real-time capability or in which a weighted hybrid of the fastest possible transmission and the greatest possible probability of fulfillment of real-time requirements is made possible.

According to another embodiment, routing rules present in the test device are applied to the particular physical connection topology, thereby determining the data flow in the indirect physical communication links. The result can be output to the user as a control result. In the case of several physical connection topologies which are optimal according to the optimization function, it is also possible for the result to be used as a decision criterion for one of the physical connection topologies. The routing rules present in the test device can be predefined routing rules that the test device generally applies to the physical data exchange.

According to a further embodiment, the test device has at least one external input/output interface, and an input/output connection network is present between the plurality of data processing units and the at least one external input/output interface. In this case, the specified quantity of physical interfaces for each data processing unit is determined on the basis of the total number of physical interfaces of the respective data processing unit and of the input/output connection network. In particular, the quantity of physical interfaces specified for communication between the data processing units can be determined the difference between the total number of physical interfaces and the physical interfaces of the respective data processing unit that are occupied by the input/output connection network. In other words, a first quantity of physical interfaces of each data processing unit can be reserved for the input/output connection network, wherein the remainder of the physical interfaces is that quantity of physical interfaces, referred to herein as specified quantity, for the physical connection topology between the data processing units.

In this way, specifying the direct physical communication links or optimizing the direct physical communication links can take place as a step downstream of specifying the input/output connection network. The direct physical communication links between the data processing units can thus be specified independently of specifying the input/output connection network. However, it is also possible for hardware properties of the input/output connection network and/or communication properties of the external exchange of data via the input/output interface to be taken into account in the optimization with regard to specifying the direct physical communication links between the data processing units. In this respect, the database can be expanded for a most advantageous physical connection topology possible. It is also possible for the input/output connection network not to be accepted as given, but for the physical connections of the input/output connection network to be determined as part of the physical connection topology of the test device together with the direct physical communication links between the data processing units. The use of communication resources can thus be further improved. The external input/output interface may take the form of so-called I/O board(s).

According to a further embodiment, the test device is a hardware-in-the-loop simulator (HIL simulator) or a rapid control prototype (RCP).

According to a further embodiment, the plurality of data processing units is between 5 and 20 data processing units, in particular between 10 and 15 data processing units. With such a large number of data processing units, which can, for example, each have 3 or 4 physical interfaces, it is easily possible in a given simulation for the number of logical communication links to far exceed the number of possible direct physical communication links. It is precisely in such a case that the method according to the embodiments presented herein is particularly suitable for efficiently determining a physical connection topology with real-time capability.

According to a further embodiment, the method further comprises the following step: assessing the real-time capability of the test device for the particular physical connection topology. In particular, assessing the real-time capability of the test device for the particular physical connection topology may take place under the assumption of a given simulation, in particular under the assumption of given communication requirements of the plurality of simulation models. By automatically assessing the real-time capability following automated determination of the physical connection topology, the user can be notified in an integrated and highly efficient manner whether a desired simulation can be carried out with real-time capability. If required, by changing the simulation, the user can quickly access a simulation with real-time capability.

According to a further embodiment, the method further comprises the following step: outputting the physical connection topology to a user, in particular graphically outputting the physical connection topology to a user, for the manual creation of the direct physical communication links. Outputting the physical connection topology may include displaying a list of the direct physical connections or displaying the physical connection topology as a graphic. Manual creation of the direct physical communication links can include plugging in the corresponding connection lines by hand. In this way, the user can control and optionally overrule the result of the automated determination of the physical connection topology when he implements this physical connection topology.

According to a further embodiment, the method further comprises the following step: automatically creating specified direct physical communication links. In this way, the result of the automated determination of the physical connection topology can be implemented directly and without user interaction, and the simulation can be started immediately with that particular physical connection topology. The test device can be dynamically adapted to the simulation and an improved utilization of the test device can be achieved. The automated creation can in particular be an automated creation of specified direct physical communication links by switching optical switches. The automated creation of specified direct physical communication links may involve all or part of the specified direct physical communication links. The automatically created direct physical communication links can be provided in place of the manually created direct physical communication links or can also comprise redundant connections in addition to the manually created direct physical communication links.

Exemplary embodiments of the invention further comprise a method for running a simulation using a test device with real-time capability and set up for control device development, wherein the test device comprises a plurality of data processing units and wherein a plurality of simulation models is associated with the plurality of data processing units. The method comprises the following steps: determining the communication requirements of the plurality of simulation models; determining the physical connection topology of the test device according to a method according to any one of the above-described embodiments; creating the specified direct physical communication links in the test device; and running the simulation, wherein the plurality of simulation models exchange data amongst each other during the execution of the simulation. The additional features, modifications and technical effects described above for the method for determining a physical connection topology are analogously applicable to the method for performing a simulation using a test device with real-time capability and set up for control device development.

Further exemplary embodiments of the invention are described with reference to the accompanying figures.

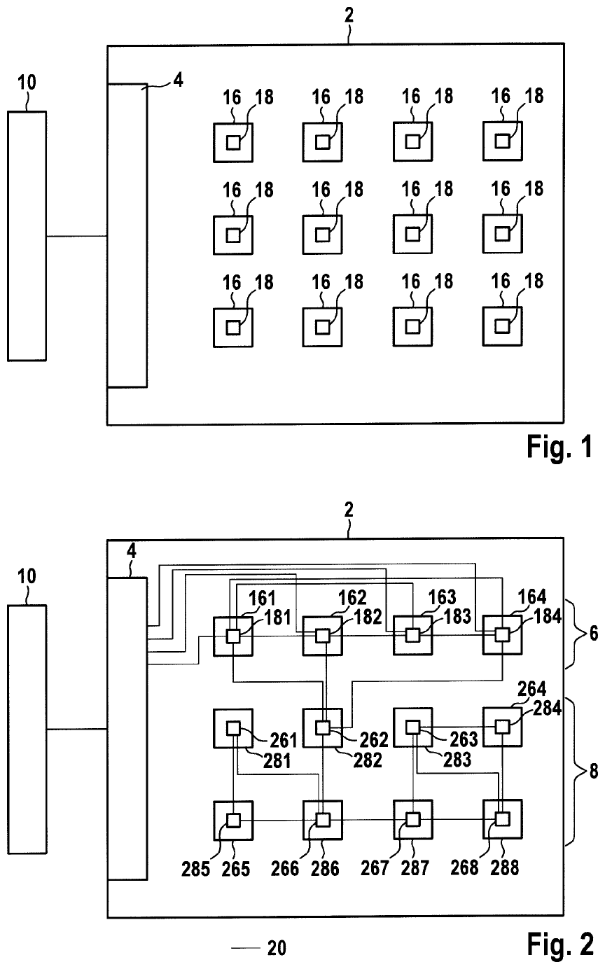

FIG. 1 shows a test device with real-time capability, which in the present case is an HIL simulator 2. The HIL simulator 2 has a physical external input/output interface 4 via which external devices can be connected to the HIL simulator 2. In FIG. 1, a control device 10 is connected to the external input/output interface 4. In the example shown in FIG. 1, the control device 10 is an engine control device, set up for controlling the engine of a motor vehicle. The HIL simulator 2 is set up for testing the engine control device.

The HIL simulator 2 includes a plurality of data processing units 16. In the exemplary embodiment in FIG. 1, twelve such data processing units 16 are provided. In the present example, each of these data processing units 16 includes a simulation model 18. The provision of exactly one simulation model 18 per data processing unit 16 is purely by way of example and serves to illustrate the configuration of the communication between the data processing units 16, as illustrated in FIGS. 2 to 4. It is possible for more than one simulation model 18 to be provided per data processing unit 16 and for different numbers of simulation models 18 to be provided in the data processing units 16. It is also possible for one or more of the data processing units 16 to have no simulation model 18 associated therewith. During operation, the relevant simulation models 18 are executed in the respective data processing units 16. They simulate various technical components, with which the control device 10 interacts directly or indirectly during the simulation. A detailed example of various technical components simulated by the simulation models 18 is described below with reference to FIGS. 2 to 4.

FIG. 2 shows a test device in an exemplary embodiment in which specific technical systems or subsystems are assigned to the data processing units and the simulation models associated therewith and in which an exemplary communication takes place between the simulation models. The test device is also an HIL simulator 2. The HIL simulator 2 in FIG. 2 can be the HIL simulator 2 of FIG. 1, in which a specific relationship of simulations of technical components was established by loading specific simulation models. For those components of FIG. 2 that are not discussed, reference is made to the above description of FIG. 1.

In the exemplary test device of FIG. 2, an engine and a gearbox are simulated. The engine in this case is the technical system to be controlled by the control device 10, while the gearbox forms part of the technical environment of the engine and of the control device 10, whose interaction with the engine is also modeled in the test device 2. In the present example, four data processing units are used for the simulation of the engine. These data processing units are a first engine data processing unit 161, a second engine data processing unit 162, a third engine data processing unit 163, and a fourth engine data processing unit 164. Each of these data processing units 161, 162, 163, 164 is associated with a corresponding simulation model. In the present case, the behavior of the engine is simulated by four engine simulation sub-models, namely by a first engine simulation sub-model 181, a second engine simulation sub-model 182, a third engine simulation sub-model 183, and a fourth engine simulation sub-model 184. The first to fourth engine data processing units 161-164 and the first to fourth engine simulation sub-models 181-184 together form the engine model 6 of the simulation.

For the simulation of the gearbox, a first gearbox data processing unit 261, a second gearbox data processing unit 262, a third gearbox data processing unit 263, a fourth gearbox data processing unit 264, a fifth gearbox data processing unit 265, a sixth gearbox data processing unit 266, a seventh gearbox data processing unit 267, and an eighth gearbox data processing unit 268 are provided in the exemplary test device of FIG. 2. Associated with these data processing units are a first gearbox simulation sub-model 281, a second gearbox simulation sub-model 282, a third gearbox simulation sub-model 283, a fourth gearbox simulation sub-model 284, a fifth gearbox simulation sub-model 285, a sixth gearbox simulation sub-model 286, a seventh gearbox simulation sub-model 287, and an eighth gearbox simulation sub-model 288. The first to eighth gearbox data processing units 261-268 and the first to eighth gearbox simulation sub-models 281-288 together form the gearbox model 8 of the simulation.

During execution of the simulation, the control device 10 interacts with the engine model 6 which in turn interacts with the gearbox model 8. In this way, the behavior and functionality of the control device 10 with respect to the engine model 6 can be tested with reference to the environment of the gearbox model 8. The communication between the individual entities is described below.

In FIG. 2, the logical communication links between the individual entities are shown in thin solid lines 20. The first to fourth engine simulation sub-models 181, 182, 183, 184 each have a logical communication link to the external input/output interface 4 and thus to the control device 10. Furthermore, the first engine simulation sub-model 181 has a logical communication link to each of the second to fourth engine simulation sub-models 182, 183, 184. Furthermore, there are logical communication links between the second engine simulation sub-model 182 and the third engine simulation sub-model 183 as well as between the third engine simulation sub-model 183 and the fourth engine simulation sub-model 184. In addition, there are logical communication links between each of the first engine simulation sub-model 181, the second engine simulation sub-model 182, and the fourth engine simulation sub-model 184 on the one side and the second gearbox simulation sub-model 282. The second gearbox simulation sub-model 282 thus constitutes the interface between the engine model 6 and the gearbox model 8. Amongst the gearbox simulation sub-models 261-268, there are a plurality of logical communication links, as can be seen in FIG. 2.

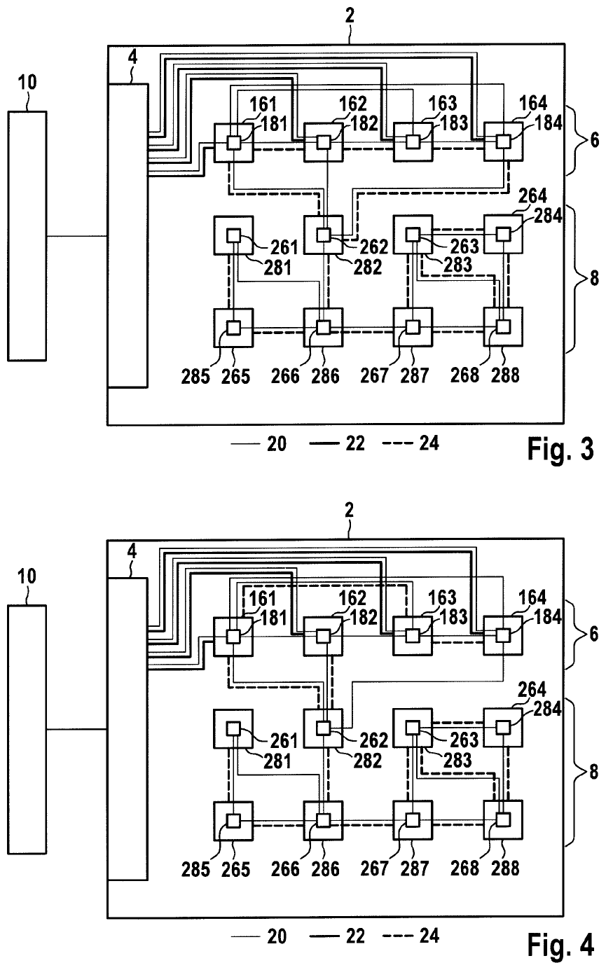

The logical communication links corresponding to thin solid lines 20 represent the data exchange between the individual simulation sub-models in its entirety. Each logical communication link corresponds to a connection of two simulation sub-models exchanging data during the simulation, wherein the data exchange may be unidirectional or bidirectional. For the purpose of performing the simulation, a physical connection topology, via which the data exchange can be handled physically, is created between the data processing units for the given logical communication links corresponding to thin solid lines 20. Exemplary specifications of the physical connections are described below with reference to FIGS. 3 and 4.

FIG. 3 shows the HIL simulator 2 and the control device 10 of FIG. 2. Again, the logical communication links are represented by thin solid lines 20. In addition, the physical communication links between the entities of the HIL simulator 2 are shown in FIG. 3. On the one hand, the physical connections between the individual data processing units and the external input/output interface 4 are represented by bold solid lines 22 and on the other hand, the direct physical communication links between the data processing units are represented by bold dashed lines 24. The determination of the physical connection topology based on the logical communication links corresponding to thin solid lines 20 is set forth below.

The method for determining the physical connection topology assumes the following basic conditions. In the exemplary embodiment in FIG. 3, each of the data processing units 161-164 and 261-268 has three physical interfaces. In other words, three physical data lines may depart from or arrive at each of the data processing units. Furthermore, it is specified that for each logical communication link between a simulation sub-model and the external input/output interface 4, a corresponding physical connection is to be provided between the associated data processing unit and the external input/output interface. Hence, for each of the first to fourth engine data processing units 161, 162, 163, 164, a physical communication link to the external input/output interface 4 is provided, here represented by bold solid lines 22. These four physical communication links form the input/output connection network of the HIL simulator 2. Thus, for each of the first to fourth engine data processing units 161-164 only two physical interfaces are available for the communication between the data processing units. In other words, two is the quantity of physical interfaces specified for the first to fourth engine data processing units 161-164. For the first to eighth gearbox data processing units 261-268, the specified quantity of physical interfaces is three.

The direct physical communication links are defined on the basis of the specified quantities of physical interfaces available. In the exemplary embodiment in FIG. 3, the direct physical communication links are determined with the optimization goal that for a minimum number of logical communication links, one indirect physical communication link, i.e. a physical communication link through a data processing unit not involved in the logical communication link, be provided. In other words, the method according to an exemplary embodiment of the invention attempts to create direct physical communication links for as many of the logical communication links corresponding to thin solid lines 20 as possible.

The result of this optimization is illustrated in FIG. 3 by the bold dashed lines 24 representing the direct physical communication links between the data processing units. In the present example, there is a direct physical communication link for fourteen logical communication links between each two data processing units. Only four logical communication links have no direct physical communication link. The corresponding data must then be routed via an intermediate data processing unit. The data between the first engine data processing unit 161 and the third engine data processing unit 163 may be forwarded, for example, by the second engine data processing unit 162. The data between the first engine data processing unit 161 and the fourth engine data processing unit 164 may be forwarded, for example, by the second gearbox data processing unit 262. The data between the second engine data processing unit 162 and the second gearbox data processing unit 262 may be forwarded, for example, by the first engine data processing unit 161. The data between the first gearbox data processing unit 262 and the sixth gearbox data processing unit 266 may be forwarded by the fifth gearbox data processing unit 265.

Thus, there is at least one indirect physical communication link for all logical communication links. In addition, as required by the basic conditions, at most three physical interfaces are used at each data processing unit. The total number of all hops over all indirect physical communication links is four and is thus also minimal in the case of the physical connection topology shown in FIG. 3. The physical connection topology in FIG. 3 is thus also a result at which the method could have arrived within the context of a minimization of hops in the indirect physical communication links.

FIG. 4 shows the result of a differently oriented optimization for the same case of the HIL simulator 2 of FIG. 2 with the logical communication links corresponding to thin solid lines 20 shown therein. According to the method of the exemplary embodiment of the invention of FIG. 4, the optimization function takes into account not only the number of hops but also the latency in forwarding the data in an intermediate data processing unit and also the data rate of a logical communication link. For example, the optimization function could minimize the sum of the product of the hops, latency per hop, and data rate over all logical communication links that are not implemented by direct physical communication links.

Furthermore, determination of the physical connection topology of the embodiment in FIG. 4 is based on the assumption that the logical communication link between the first engine simulation sub-model 181 and the third engine simulation sub-model 183 as well as the logical communication link between the second engine simulation sub-model 182 and the second gearbox simulation sub-model 282 have such high data rates that indirect physical connections, i.e. physical connections with more than 0 hops, have such a great influence on the aforementioned optimization function that only direct physical connections for these two logical communication links can result in an optimal result according to the optimization function. When comparing FIG. 4 to FIG. 3, it can be seen that there are now direct physical communication links corresponding to bold dashed lines 24 between the first engine data processing unit 161 and the third engine data processing unit 163 as well as between the second engine data processing unit 162 and the second gearbox data processing unit 262.

Since the specified quantity of physical interfaces for each data processing unit, as stated above, must not be exceeded, other direct physical communication links need to be eliminated. Overall, according to the embodiment in FIG. 4, there are now five logical communication links for which there are no direct communication links. In addition, for the logical communication link between the second engine simulation sub-model 182 and the third engine simulation sub-model 183, there is only one indirect physical communication link with two hops, namely via the second gearbox data processing unit 262 and the first engine data processing unit 161.

FIG. 4 is thus an exemplary example that makes it clear that an optimization function can also lead to results that do not minimize the number of indirect physical communication links or the number of hops in the indirect physical communication links, but that nevertheless do yield an optimized physical connection topology in light of further parameters, such as latency in the hops and the data rate of the logical communication links.

After such a physical connection topology has been automatically determined, the input/output connection network corresponding to bold solid lines 22 and the direct physical communication links corresponding to bold dashed lines 24 can be manually plugged in or created automatically by switching the corresponding connections of corresponding lines to the data processing units or to the input/output interface 4.

The method for determining the physical connection topology can be executed in the HIL simulator 2. It is also possible for the method to be executed in an external device, such as an external computer that, for the purpose of configuring the simulation, is connected to the HIL simulator 2.

It is again emphasized that the examples in the figures are only exemplary and are intended to illustrate the method according to exemplary embodiments of the invention. In particular, the number of data processing units, of simulation models, of physical interfaces per data processing unit as well as the type and number of logical communication links are given purely by way of example. The parameters on which the optimization function is based are also purely exemplary. All parameters mentioned herein can be taken into account in any combination.

Although the invention has been described with reference to exemplary embodiments, it is apparent to a person skilled in the art that various changes may be made and equivalents employed without departing from the scope of the invention. The invention is not intended to be limited by the specific embodiments described. Rather, it includes all embodiments covered by the appended claims.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for determining a physical connection topology of a test device with real-time capability and set up for control device development,
wherein the test device comprises a plurality of data processing units, wherein each data processing unit has a specified quantity of physical interfaces for communication between the data processing units, and
wherein a plurality of simulation models is are associated with the plurality of data processing units, wherein the plurality of simulation models comprises at least one model of a technical system to be controlled and/or at least one model of a controller of a technical system; and/or at least one technical environment model,
wherein the method comprises:
determining the logical communication links between the plurality of simulation models, wherein each logical communication link represents a data link between two of the plurality of simulation models, and wherein the specified quantity of physical interfaces for a respective data processing unit of the plurality of data processing units is smaller than a quantity of logical communication links associated with the respective data processing unit; and
automatically determining the physical connection topology by specifying direct physical communication links between the plurality of data processing units based on the respective specified quantities of physical interfaces of the plurality of data processing units, wherein specifying the direct physical communication links includes determining, for each of the logical communication links, whether a direct physical communication link corresponding to the logical communication link forms part of the physical connection topology.

2. The method according to claim 1, wherein specifying the direct physical communication links is based on an optimization function.

3. The method according to claim 2, wherein the optimization function takes into account the number of logical communication links for which no direct physical communication link forms part of the physical connection topology.

4. The method according to claim 2, wherein the optimization function takes into account the number of data processing units passed through for logical communication links for which no direct physical communication link forms part of the physical connection topology.

5. The method according to claim 2, wherein the optimization function takes into account at least one hardware property of at least one of the data processing units, the physical interfaces of the data processing units, or the physical communication links.

6. The method according to claim 5, wherein the at least one hardware property includes at least one property of latency, maximum data throughput, or collision handling.

7. The method according to claim 2, wherein the optimization function takes into account at least one communication property of the logical communication links.

8. The method according to claim 7, wherein the at least one communication property includes at least one property of the data transmission direction, the clock rate of data to be transmitted, the data volume, or the data requirements of asynchronous events.

9. The method according to claim 5, wherein the optimization function is used to determine a physical connection topology that allows as fast and/or stable a data exchange as possible of the simulation models over the totality of logical communication links.

10. The method according to any one of the claim 1, wherein the test device has at least one external input/output interface and wherein an input/output connection network is present between the plurality of data processing units and the at least one external input/output interface, wherein the specified quantity of physical interfaces for each data processing unit is determined based on the total number of physical interfaces of the respective data processing unit and of the input/output connection network.

11. The method according to claim 1, wherein the test device is a hardware-in-the-loop simulator or a rapid control prototype.

12. The method according to claim 1, further comprising:
assessing the real-time capability of the test device for the particular physical connection topology.

13. The method according to claim 1, further comprising:
graphically outputting the physical connection topology to a user to facilitate creation of the direct physical communication links.

14. The method according to claim 1, further comprising:
automatically creating specified direct physical communication links by switching optical switches.

15. A method for running a simulation using a test device with real-time capability and set up for control device development, wherein the test device has a plurality of data processing units and wherein a plurality of simulation models is are associated with the plurality of data processing units, the method comprising:
specifying communication requirements of the plurality of simulation models;
determining a physical connection topology of the test device, wherein determining the physical connection topology of the test device comprises:
determining logical communication links between the plurality of simulation models, wherein each logical communication link represents a data link between two of the plurality of simulation models, and wherein a specified quantity of physical interfaces for a respective data processing unit of the plurality of data processing units is smaller than a quantity of logical communication links associated with the respective data processing unit; and
automatically determining the physical connection topology by specifying direct physical communication links between the plurality of data processing units based on respective specified quantities of physical interfaces of the plurality of data processing units, wherein specifying the direct physical communication links includes determining, for each of the logical communication links, whether a direct physical communication link corresponding to the logical communication link forms part of the physical connection topology;
creating the specified direct physical communication links in the test device; and
running the simulation, wherein the plurality of simulation models exchange data with each other during execution of the simulation.
